(19) United States
(12) Patent Application Publication
(10) Pub. No.: US 2021/0191904 A1
(43) Pub. Date: Jun. 24, 2021

(54) Cloud Database System With Multi-Cash For Reducing Network Cost In Processing Select Query

(71) Applicant: TmaxData Co., Ltd., Gyeonggi-do (KR)

(72) Inventors: Jeongwoo LEE, Gyeonggi-do (KR); Sang Young PARK, Seoul (KR); Hakyong LEE, Gyeonggi-do, (KR); Taikyoung KIM, Gyeonggi-do (KR); Bobae KIM, Gyeonggi-do (KR)

(21) Appl. No.: 16/796,687

(22) Filed: Feb. 20, 2020

(30) Foreign Application Priority Data
Dec. 24, 2019 (KR) 10-2019-0173762

(51) Int. Cl. G06F 16/14; G06F 16/182; G06F 16/16; G06F 9/54

(52) U.S. Cl. CPC G06F 16/156; G06F 16/152; G06F 9/544; G06F 16/164; G06F 9/546; G06F 16/1824

(57) ABSTRACT

Disclosed is a back-end node in a cloud database system according to some exemplary embodiments of the present disclosure to solve the problems. The back-end node may include a communication unit; a back-end cache storing buffer cache data and metadata information, wherein the buffer cache data and the metadata information correspond to a data block stored in the database system; and a processor, wherein the metadata information includes information of a front-end node which stores the data block in its front-end cache.

### CROSS-REFERENCE TO RELATED APPLICATIONS

This application claims priority to and the benefit of Korean Patent Application No. 10-2019-0173762 filed in the Korean Intellectual Property Office on Dec. 24, 2019, the entire contents of which are incorporated herein by reference.

### TECHNICAL FIELD

The present disclosure relates to a cloud system, and particularly, to a system for enhancing performance of a select query.

### BACKGROUND ART

A conventional database system is constituted by a front-end node of making a query plan by receiving a query from a user and a back-end node of reading a data block through a buffer cache (i.e., back-end cache) on an actual disk and sending the read data block to a front-end node when receiving a request for the data block from the front-end node.

In such an environment, when the front-end node always requests the data block to the back-end node for frequently accessed data blocks, network cost required for operating a system increases, which may degrade performance of an entire database system.

Accordingly, there may be a demand for a method for reducing the network cost in operating the database system in the art.

### SUMMARY OF THE INVENTION

The present disclosure has been made in an effort to provide a system for reducing network cost in processing a select query.

However, technical objects of the present disclosure are not restricted to the technical object mentioned as above. Unmentioned technical objects will be apparently appreciated by those skilled in the art by referencing to the following description.

An exemplary embodiment of the present disclosure provides a back-end node for a cloud database system which may include a communication unit; a back-end cache storing buffer cache data and metadata information, wherein the buffer cache data and the metadata information correspond to a data block stored in the database system; and a processor, wherein the metadata information includes information of a front-end node which stores the metadata block in its front-end cache.

The back-end cache may further include a buffer header corresponding to the buffer cache data, and the buffer header may include the metadata information.

The back-end cache may include a buffer header corresponding to the buffer cache data, and the metadata information may share the same search structure with the buffer cache data.

The buffer header and the metadata information may share the search structure by being stored in the back-end cache using same hash function, having the same input value for the hash function related to the buffer header and the metadata information, and the space in which the buffer header and the metadata information are stored within the search structure, and the result value attained from inputting the input value to the hash function being related.

The metadata information may include one of the following: a bitmap, a node ID information in the form of an array or a node ID information expressed as B+ Tree in the shared memory space.

The processor may search at least either one of the first buffer cache data or the first metadata information in the back-end cache when receiving a request to send a first data block from a first front-end node through the communication unit, control the communication unit to send the first data block to the first front-end node based on at least either one of the first buffer cache data or the first metadata information when the first buffer cache data is searched or there exists sharing information on the searched first metadata information, and store the first sharing information on the first data block to the first metadata information, wherein the first sharing information on the first data block is information which indicates that the first data block is stored on the first front-end node.

The processor may search second sharing information on the first data block included in the first metadata information when there exists sharing information in the first metadata information, wherein the second sharing information on the first data block indicates that the first data block is stored on a second front-end node, receive the first data block from the second front-end node through the communication unit, and control the communication unit to send received first data block to the first front-end node.

When the first metadata information does not exist in the back-end cache, the processor may generate or loads a first data structure which is able to store the first metadata information, store information of the first data block to the first data structure, and decide the first data structure as the first metadata information.

The processor may control the communication unit to send the first buffer cache data to the first front-end node, when the first buffer cache data exists in the back-end cache.

The processor may control the communication unit to send a request signal for the first data block to a disk when the first buffer cache and the sharing information does not exist in the searched first metadata information, and control the communication unit to send the first data block to the first front-end node when receiving the first data block from the disk.

The processor may search second metadata information when the communication unit receives an update request on a second data block from the first front-end node, and conduct updates on the second data block with reference to the second metadata information.

The processor may search first sharing information on the second data block included in the second metadata information when the second metadata information exists in the back-end cache, wherein the first sharing information on the second data block indicates that the second data block has been stored in the first front-end node, receive the second data block from the first front-end node through the communication unit, store the second data block to the back-end cache, and conduct updates on the second data block.

The processor may recognize one or more front-end nodes which has stored the second data block using the second metadata information, control the communication unit to send an invalidate signal that makes one or more front-end node invalidate the second block from front-end cache of each of the one or more front-end nodes, and conduct updates on the second data block synchronously or asynchronously and controls the communication unit to send invalidate signals.

The processor may act as the following when the updates on the second data block are asynchronously done with sending invalidate signals, conduct updates on the second data block, recognize whether the completion signal on the invalidate signals are received from all of one or more front-end nodes, and send an update completion signal on the second data block to the first front-end node when the completion signal on the invalidate signals are received from all of one or more front-end nodes.

The processor may conduct updates on the second data block, when the second metadata information does not exist.

The processor may search third metadata information when a signal that a third data block has been invalidated from the first front-end node is received from the first front-end node, and delete the first sharing information on the third data block from the third metadata information, wherein the first sharing information on the third data block indicates that the third data block is stored in the first front-end node.

The processor may update fourth metadata information on a fourth data block based on the cache out signal, when the communication unit receives the cache out signal that indicates the fourth data block is cached out from the first front-end node from the first front-end node.

The processor may store fifth metadata information on a fifth data block in a memory of the back-end node when the fifth data block is cached out from the back-end cache.

The processor may re-load the fifth metadata information when the fifth data block is read again into the back-end node.

When the fifth metadata information is re-loaded, the processor may recognize the fifth metadata information when it recognizes that the fifth data block has been read into the back-end cache, and record the fifth metadata information on the buffer header related to the fifth data block.

The processor may recognize sixth metadata information corresponding to a sixth data block, recognize at least one front-end node that stores the sixth data block in front-end cache based on the sixth metadata information, control the communication unit to send an invalidate signal on the sixth data block to at least one of the front-end nodes, and delete the sixth metadata information from the back-end cache when a completion signal for the invalidate signal on the sixth data block is received from all of the front-end nodes.

Another exemplary embodiment of the present disclosure provides a front-end node in a cloud database system to solve the problems described above. The front-end node may include: a front-end cache storing one or more data blocks; a communication unit receiving data blocks related to select query from a back-end node; and a processor storing the data block to the front-end cache when the data block has been decided to be stored in the front-end cache.

The front-end node may further include an optimizer that decides if the data block is to be stored in the front-end cache or not using at least one of the following: a type of scan, a size of a target segment, level of filtering or access frequency.

The processor may search the first data block from the front-end cache when receiving a request signal for a first data block from the back-end node, and send the first data block to the back-end node when the first data block exists in the front-end cache.

The processor may invalidate the third data block from the front-end cache when an invalidate signal for the third data block to be invalidated from the front-end cache is received from the back-end node, and control the communication unit to send a completion signal for the invalidate signal that indicates that the third data block has been invalidated to the back-end node.

The processor may switch the state of the third data block to CR (Consistent Read) state which is stored in the front-end cache as a current state when invalidating the third data block from the front-end cache.

The processor may recognize a fourth data block when cached out from the front-end cache, control the front-end cache to cache out the fourth data block from the front-end cache, and control the communication unit to send the cache out signal which indicates that the fourth data block has been cached out from the front-end cache to the back-end node.

According to an exemplary embodiment of the present disclosure, performance of a select query can be enhanced.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a schematic view of an exemplary cloud database system including a front-end node and a back-end node according to some exemplary embodiments of the present disclosure.

FIG. 2 is a block diagram illustrating a configuration of a front-end node according to some exemplary embodiments of the present disclosure.

FIG. 3A is a diagram illustrating an aspect in which a buffer header, metadata information, and buffer cache data are stored in a back-end cache of a back-end node according to some exemplary embodiments of the present disclosure.

FIG. 3B is a diagram illustrating one example of a specific method for sharing a search structure.

FIG. 4 is a flowchart illustrating that a processor of a back-end node transfers a data block to a front-end node according to some exemplary embodiments of the present disclosure.

FIG. 5 is a flowchart illustrating a process in which a processor of a back-end node updates a data block according to some exemplary embodiments of the present disclosure.

FIG. 6 is a flowchart illustrating a process in which a processor of a back-end node updates information of a data block invalidated in a front-end node according to some exemplary embodiments of the present disclosure.

FIG. 7 is a flowchart illustrating a process in which when a data block is cached out from a front-end cache, a processor of a back-end node updates the data block according to some exemplary embodiments of the present disclosure.

FIG. 8 is a flowchart illustrating a process in which when a data block which is cached out is stored in a back-end cache again, a processor of a back-end node loads metadata information according to some exemplary embodiments of the present disclosure.

FIG. 9 is a flowchart illustrating a process in which a processor of a back-end node deletes metadata information of a data block from a back-end cache according to some exemplary embodiments of the present disclosure.

FIG. 10 is a flowchart illustrating a process in which a processor of a front-end node stores a data block in a front-end cache according to some exemplary embodiments of the present disclosure.

FIG. 11 is a simple and general schematic view for an exemplary computing environment in which some exemplary embodiments of the present disclosure may be implemented.

### DETAILED DESCRIPTION

Various exemplary embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is decided that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

It is also to be understood that the terminology used herein is for the purpose of describing embodiments only and is not intended to limit the present disclosure. In this specification, singular forms include even plural forms unless the context indicates otherwise. It is to be understood that the terms “comprise” and/or “comprising” used in the specification does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined. Moreover, the term “or” is intended to mean not exclusive “or” but inclusive “or”.

That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items. Further, the terms “information” and “data” used in the specification may also be often used to be exchanged with each other.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is decided that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The computer readable medium in the present specification may include all kinds of storage media storing programs and data so as to be readable by the computer system. The computer readable media in the present disclosure may include both computer readable storage media and computer readable transmission media. According to an aspect of the present disclosure, the computer readable storage media may include a read only memory (ROM), a random access memory (RAM), a compact disk (CD)-ROM, a digital video disk (DVD)-ROM, a magnetic tape, a floppy disk, an optical data storage device, and the like. Further, the computer readable transmission media may include a predetermined medium of a type which is transmittable, which is implemented in a type of a carrier wave (e.g., transmissions through the Internet). Additionally, the computer readable media are distributed to systems connected through network to store computer readable codes and/or commands in a distribution scheme.

Prior to describing detailed contents for carrying out the present disclosure, it should be noted that configurations not directly associated with the technical gist of the present disclosure are omitted without departing from the technical gist of the present disclosure. Further, terms or words used in the present specification and claims should be interpreted as meanings and concepts which match the technical spirit of the present disclosure based on a principle in which the inventor can define appropriate concepts of the terms in order to describe his/her invention by a best method.

In the present disclosure, the query means a predetermined request or command of requesting processing in a back-end node and may include, for example, data manipulation language (DML), data definition language (DDL), and/or PL/SQL. Further, the query in the present disclosure may mean a predetermined request issued from a user/developer. Further, the query may mean a predetermined request which is input into a front-end node and/or a back-end node and processed in the front-end node and/or the back-end node.

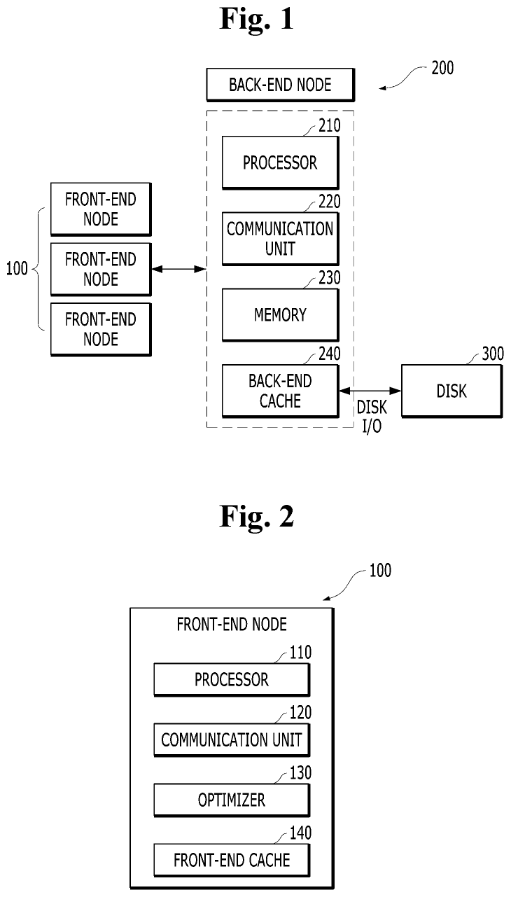

FIG. 1 is a schematic view of an exemplary cloud database system including a front-end node and a back-end node according to some exemplary embodiments of the present disclosure.

A front-end node and a back-end node in a cloud computing environment according to the present disclosure constitute a database system under a cloud computing environment. Cloud computing means a computer environment in which information is persistently stored in a back-end or a disk and temporarily kept in a front-end such as an IT device such as a desktop, a tablet computer, a notebook, a netbook, a smart phone, etc. In other words, the cloud computing is a concept that all information of a user is stored in a server and the information may be used through various IT devices anywhere anytime.

In other words, the cloud computing refers to a technology that integrates and provides computing resources (i.e., a front-end node 100 and a back-end node 200) which exist at different physical locations with a virtualization technology.

Under such a cloud computing environment, a database system is constituted by a front-end node 100 of making a query plan by receiving a query from a user and a back-end node 200 of reading a data block through a buffer cache (i.e., back-end cache) on an actual disk and sending the read data block to a front-end node when receiving a request for the data block from the front-end node.

Under a general cloud computing environment, in a database system, a separate cache is not provided in a front-end. Accordingly, when the front-end node always requests the data block to the back-end node for frequently accessed data blocks, network cost required for operating a system increases, which may degrade performance an entire database system.

In order to solve such a problem, according to the present disclosure, a front-end cache 140 is added to the front-end node 100 to reduce the network cost required for operating the database system, thereby enhancing performance of an entire system. This will be described below in detail in FIG. 2.

As illustrated in FIG. 1, the system may include the front-end node 100 and the back-end node 200. The front-end node 100 and the back-end node 200 may be connected to each other by a predetermined network (not illustrated).

As illustrated in FIG. 1, the front-end node 100 may mean a predetermined type of node(s) in a cloud database system having a mechanism for communication through a network. For example, the front-end node 100 may include a personal computer (PC), a laptop computer, a workstation, a terminal, and/or a predetermined electronic device having network connectivity. Further, the front-end node 100 may include a predetermined server implemented by at least one of agent, application programming interface (API), and plug-in. In addition, the front-end node 100 may include an application source and/or a client application.

The front-end node 100 may be a predetermined entity which includes a processor and a memory to process and store predetermined data. Further, the front-end node 100 in FIG. 1 may be related with a user which uses the back-end node 200 or communicates with the back-end node 200. In such an example, the front-end node 100 may issue a query to the back-end node 200. In one example, when the front-end node 100 generates the query to the back-end node 200, the corresponding query may be processed in the form of a transaction in the back-end node 200. In other words, the front-end node 100 may allow the back-end node 200 to generate and process the transaction. The front-end node 100 may receive an application source created by a programming language by a developer, etc. Further, for example, the front-end node 100 compiles the application source to create the client application. For example, the created client application may be transferred to the back-end node 200 and thereafter, optimized and executed.

The back-end node 200 may include a predetermined type of computer system or computer device such as a microprocessor, a mainframe computer, a digital processor, a portable device, and a device controller. The back-end node 200 may include a database system (not illustrated), a processor 210, a communication unit 220, a memory 230, and a back-end cache 240. Further, the back-end node 200 may send and receive data through disk input/output for an external disk 300. In FIG. 1, one back-end node and three front-end nodes are exemplarily illustrated, but it will be apparent to those skilled in the art that more back-end nodes (management apparatuses) and front-end nodes therethan may also be included in the scope of the present disclosure.

As illustrated in FIG. 1, the back-end node 200 may include one or more memories 230 including a buffer cache. Further, as illustrated in FIG. 1, the back-end node 200 may include one or more processors 210. Therefore, the cloud database system may be operated by the processor 210 on the memory 230.

The processor 210 may be constituted by one or more cores and may include processors of predetermined types, which include a central processing unit (CPU), a general purpose graphics processing unit (GPGPU), a tensor processing unit (TPU), and the like of the computing device. The processor 210 may read a computer program stored in the memory 230 to perform the method for enhancing performance of a select query according to an exemplary embodiment of the present disclosure.

The processor 210 may decide to temporarily or permanently store any data and log information that is stored in association with the query being received from the front-end node 100 into the back-end node 200. The processor 210 may decide to store a data table and/or an index table. The processor 210 may decide a storage location of the stored data and/or log information on the memory 230 or a storage location on the disk 300.

The memory 230 may store a program for a motion of the processor 210 therein and temporarily or permanently store input/output data (e.g., an update request, a data block, a buffer header 400, etc.). The memory 230 may include at least one type of storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The memory 230 may be operated by the control by the processor 210.

The memory 30 according to some exemplary embodiments of the present disclosure may store a data block including a data value. The data block may include the data value and in an exemplary embodiment of the present disclosure, the data value of the data block may be written in the disk 300 from the memory 230.

In an additional aspect, the back-end node 200 according to some exemplary embodiments of the present disclosure may include a back-end cache 240.

FIG. 2 is a block diagram illustrating a configuration of a front-end node according to some exemplary embodiments of the present disclosure.

The front-end node 100 may include a predetermined type of computer system or computer device such as a microprocessor, a mainframe computer, a digital processor, a portable device, and a device controller.

The front-end node 100 may include a database system (not illustrated), a processor 110, a communication unit 120, an optimizer 130, and a front-end cache 140. However, components described above are not required in implementing the front-end node 100 and the front-end node 100 may thus have components more or less than components listed above. Here, respective components may be configured as separate chips, modules, or devices and may be included in one device.

Further, although not illustrated in FIG. 2, the front-end node 100 may include one or more memories (not illustrated). Further, as illustrated in FIG. 2, the front-end node 100 may include one or more processors 110. Therefore, the cloud database system may be operated by the processor 110 on the memory (not illustrated).

The processor 110 may be constituted by one or more cores and may include processors of predetermined types, which include a central processing unit (CPU), a general purpose graphics processing unit (GPGPU), a tensor processing unit (TPU), and the like of the computing device. The processor 110 may read a computer program stored in the memory to perform the method for enhancing performance of a select query according to an exemplary embodiment of the present disclosure.

The processor 110 may decide to temporarily or permanently store any data and log information that is stored in association with the query being received into the front-end node 100 from the outside. The processor 110 may decide to store a data table and/or an index table. The processor 110 may decide a storage location of the stored data and/or log information on the memory 230 or a storage location on the disk 300.

Meanwhile, the processor 110 may control the overall operation of the front-end node 100.

In the present disclosure, the optimizer 130 may be defined as a component or module that selects an optimal (lowest-cost) processing path capable of executing a SQL statement requested by the user most efficiently and quickly.

In some exemplary embodiments according to the present disclosure, the optimizer 130 may decide whether to store the data block in the front-end cache using at least one of a type of scan, a size of a target segment, a level of filtering, or an access frequency.

The optimizer 130 may be a part of a program stored in a computer readable storage medium according to the present disclosure, or may mean a processor in which the program is driven.

A type of scan associated with the select query decided by the optimizer 130 may be, for example, a table full scan or an index scan. However, the present disclosure is not limited thereto.

A table full scan may be defined by a method of reading all rows that exist in a table. On the other hand, the index scan may be defined by a method of reading data using an index associated with a specific table.

When the index scan is conducted, a probability that a specific data block stored in the front-end cache 140 is to be often accessed is high and the number of data blocks to be accessed is small. Accordingly, when the front-end cache 140 is searched, there is a high probability that the first data block associated with the select query is to be searched, and thus the improvement of performance by using the front-end cache 140 can be expected. That is, when the optimizer 130 recognizes that the type of the scan associated with the select query is an index scan, the optimizer 130 may decide to store the data block associated with the select query in the front-end cache 140. However, the present disclosure is not limited thereto.

However, when a table full scan is used, the number of data blocks accessed is large, and the filtering on the data blocks obtained by the scan (filtering means a function of selecting only data that satisfies a user-defined condition) frequently occurs. Thus, if there are few data blocks to be actually used, the benefits obtained by using the front-end cache 140 are not large. In other words, if the table full scan is used, it may be appropriate to conduct storage on the front-end cache 140 only when there is little result filtering on the small table. That is, when the optimizer 130 recognizes that the type of the scan associated with the select query is the table full scan and the result filtering on the small table is small, the optimizer 130 may decide to store the data block associated with the select query in the front-end cache 140. However, the present disclosure is not limited thereto.

A segment according to the present disclosure may mean an object using a disk storage space. In other words, any object having a storage space may be a segment.

If the size of the segment is large, there may be many surplus blocks other than the data block associated with the select query. Therefore, storing the entire corresponding segment in the front-end cache may use a cache space inefficiently. Thus, in general, the optimizer 130 may decide not to store the corresponding segment in the front-end cache 140 when the segment size is large.

Furthermore, the access frequency according to the present disclosure may mean the number of access requests per unit time for any data block associated with the select query.

For example, the optimizer 130 may be configured to store the corresponding data block in the front-end cache 140 as the frequency of past accesses to any data block associated with the select query is higher. On the contrary, the optimizer 130 may be configured to store the corresponding data block in the front-end cache 140 as the frequency of past accesses to any data block associated with the select query is lower.

The front-end cache 140 according to some exemplary embodiments of the present disclosure may be allocated from the memory of the front-end node by the processor 110 (i.e., the front-end cache 140 may be a part of memory).

According to some exemplary embodiments of the present disclosure, the optimizer 130 may decide whether to first search the front-end cache in order to return the data block associated with the select query in consideration of a type of scan (i.e., whether it is a table full scan, an index scan, etc.), a size of a target segment, a level of filtering, an access frequency, or the like.

The front-end cache 140 may temporarily store data (e.g., the update request, the data block, the buffer header 400, etc.) input/output from the back-end node 200. The front-end cache 140 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The front-end cache 140 may be operated under control of the processor.

However, in the multi-cache configuration according to the present disclosure, the correction operation on the data block including the update of the data block may occur in the back-end cache 240 having a read/write cache. Accordingly, in a preferred exemplary embodiment, the front-end cache 140 may be a read-only cache.

As described above, by adding a cache to the front-end node, frequently used blocks may be directly found in the front-end cache, thereby reducing network cost required for query processing.

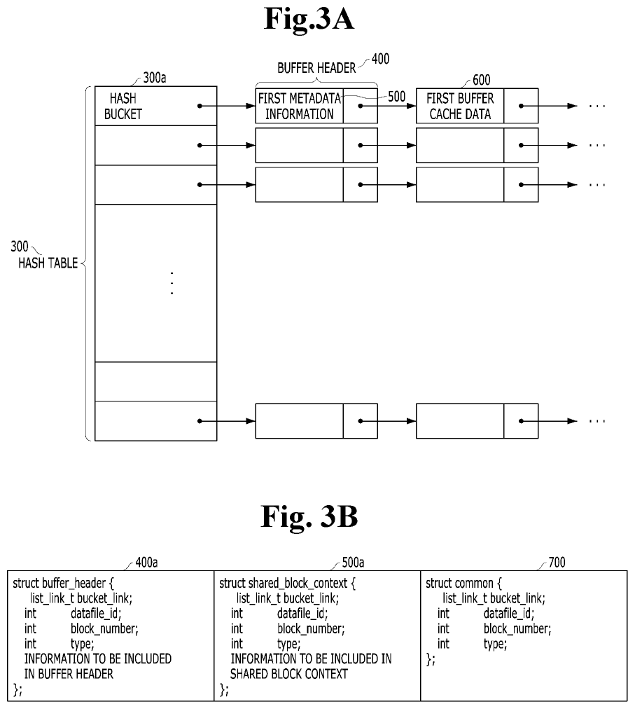

FIG. 3A is a diagram illustrating an aspect in which a buffer header 400, metadata information, and buffer cache data are stored in a back-end cache of a back-end node according to some exemplary embodiments of the present disclosure.

The buffer header 400 according to some exemplary embodiments of the present disclosure may include metadata information about the front-end node 100 that stores any data block in the front-end cache 140.

For example, if a first data block is stored at a first front-end node and a second front-end node, the buffer header 400 of the first data block may be associated with node IDs of the first front-end and the second front-end, or identification information corresponding thereto. Since this is only an example of metadata information, a specific form of the metadata information is not limited thereto.

The buffer header 400 according to the present disclosure may exist for each data block. The buffer header 400 may be defined as data managing one or more pieces of front-end node information storing a data block associated with the buffer header 400 in the front-end cache. The buffer header 400 may be used for managing of data blocks stored in the front-end cache 140 and the back-end cache 240 and sending of data blocks between the front-end nodes.

The metadata information according to some exemplary embodiments of the present disclosure may mean information about a front-end to which a specific data block is shared, and such metadata information may be stored in any data structure that stores the shared front-end information.

In the present disclosure, first metadata information 500 may mean information of front-end nodes that have stored the first data block in the front-end cache. In addition, second metadata information may mean information of front-end nodes that have stored the second data block in the front-end cache. In the present disclosure, for convenience of description, one piece of metadata information is expressed to correspond to one data block, but a relationship between the metadata information and the data block is not limited thereto.

Specifically, any buffer header 400 according to some exemplary embodiments of the present disclosure may include information of the front-end node 100 that has brought the data block corresponding to the buffer header 400 into a current (for example, a predetermined management number, a serial number, or the like) as metadata information. As the metadata information, a pointer indicating node ID information expressed in the form of a bitmap, an array, or a B+ tree may be used.

The sharing information according to some exemplary embodiments of the present disclosure may refer to information indicating whether any data block has been stored in any front-end cache.

For example, the sharing information may be a bit form. Here, it is assumed that a bit value of the first sharing information about the first data block is 1. In this case, the processor 210 may recognize that the first sharing information about the first data block exists. In contrast, if the bit value of the first sharing information about the first data block is 0, the processor 210 may recognize that there is no first sharing information about the first data block.

As another example, the sharing information may be expressed in a chain form. In this case, the processor 210 may recognize the presence of the first sharing information according to whether the first sharing information about the first data block exists on a chain.

In addition, the sharing information may include information about the number of front-end nodes storing any data block in the front-end cache. For example, if a value of the information about the number of front-end nodes storing the first data block in the front-end cache is 0, the processor 210 may recognize that there is no sharing information about the first data block.

This is merely an example of a method of recognizing sharing information about any data block by the processor 210. A format of the sharing information and a recognition method thereof are not limited to those described above, and may be appropriately modified according to a format of the sharing information illustrated in the present disclosure and the metadata information consisting of the sharing information.

That is, the first sharing information about the first data block may mean information indicating that the first data block has been stored in the front-end cache of the first front-end node.

As another example, the first sharing information about the second data block may mean information indicating that the second data block has been stored in the front-end cache of the first front-end node.

The metadata information according to the present disclosure may include individual sharing information, and the synthesis of individual sharing information about any data block may constitute metadata information.

For example, when there are three front-end nodes according to an exemplary embodiment of the present disclosure, the first metadata information 500 about the first data block may include first sharing information about the first data block, second sharing information about the first data block, and third sharing information about the first data block.

In some exemplary embodiments according to the present disclosure, the metadata information may be included in the buffer header 400.

The bit map information may mean information indicating whether any data block is stored in the cache of any front-end node using 0 or 1 in a field corresponding to any front-end node.

For example, when the first front-end node 100 stores the first data block in the front-end cache 140, the bitmap information included in the buffer header 400 of the first data block may be a form in which 0 or 1 is inputted in any field included in the bitmap information. At this time, each of any field corresponds to any front-end node.

The metadata information according to some exemplary embodiments of the present disclosure may share the same search structure with the buffer cache data. Here, having the same search structure may specifically mean that the buffer header and the metadata information are included together in one hash bucket as illustrated in FIG. 3A. Accordingly, the processor 210 may find both the buffer header and the metadata information through one lock. Therefore, the search of the data block (or the buffer cache data) may be conducted efficiently.

In detail, the buffer header 400 and the metadata information may be stored in the back-end cache using the same hash function. In order to store the buffer header and the metadata information in the back-end data using a hash function, an input value of the hash function input to the hash function may be the same. In this case, the space in which the buffer header and the metadata information are stored in the search structure may be associated with a result value obtained by inputting an input value to the hash function, thereby sharing the search structure.

For example, the processor 210 may obtain a hash result value using a data file number of a block to be found in the cache and what numberth block the corresponding data block is in the file as an input value of the hash function. Using this hash result value, the processor 210 may connect the buffer header and the metadata information to a specific hash bucket 300a to store the connected buffer header and metadata information in the back-end cache 240. When the processor 210 tends to access the data block (buffer cache data) later, similarly, the processor 210 may find a hash bucket using the data file number of the corresponding block and what numberth block is the corresponding data block as an input value of the hash function. Thereafter, when the processor 210 holds a lock of the bucket and searches a list, the processor 210 may find the metadata information, the buffer header, and the buffer cache data using a single lock. Therefore, the efficiency of the search to find the buffer cache data may be achieved and the network cost may be reduced.

In addition, when the processor 210 stores the metadata information and the buffer header in the hash bucket, the processor 210 may separately generate a list for the metadata information and a list for the buffer header. Details thereof will be described below with reference to FIG. 3B.

A node ID (identification information) of the front-end node according to some exemplary embodiments of the present disclosure may have a size of 2 bytes. Thus, the metadata information for any one data block increases as the number of nodes increases. Therefore, inefficient use of the storage space may occur due to the metadata information.

Another example in which the processor 210 of the back-end node 200 according to some exemplary embodiments of the present disclosure manages metadata information will be described.

By the processor 210 of the back-end node 200 in accordance with some exemplary embodiments of the present disclosure, the ID information of the front-end node storing any data block in the front-end cache may be included in the metadata information to be expressed in a form of bitmap when the number of total front-end nodes in a cloud environment is less than a predetermined number.

When the number of total front-end nodes in the cloud environment is greater than or equal to a predetermined number and the front-end node storing any data block in the front-end cache is less than or equal to a first value, the processor 210 may convert a field associated with the node ID included in the metadata information into an array to store the node ID of the front-end node storing the corresponding data block in the front-end cache.

On the contrary, when the number of total front-end nodes in the cloud environment is greater than or equal to a predetermined number and the front-end node storing any data block in the front-end cache is greater than the first value, the processor 210 may convert the field associated with the node ID included in the metadata information into a pointer. The converted pointer may indicate a sharing memory space associated with the node ID. In this case, in the sharing memory space, the node ID of the node that has taken any data block may be expressed and stored in the form of B+ tree on the sharing memory space.

An example of the method of managing the metadata information described above will be described by assuming that a size of the field associated with the node ID included in the metadata information is 8 bytes (64 bits). When the total number of front-end nodes in the cloud environment is less than 64, the metadata information may include node IDs of front-end nodes storing any data block in the front-end cache in a bitmap form.

If the total number of front-end nodes in the cloud environment is greater than or equal to 64, when there are four or less front-end nodes storing any data block in the front-end cache, the processor 210 may configure the field associated with the node ID included in the metadata information in an array form. Accordingly, the processor 210 may record the node ID (the node ID may have a size of 2 bytes) of the front-end node storing the any data block in the front-end cache in the array.

If the total number of front-end nodes in the cloud environment is greater than or equal to 64, when there are more than four front-end nodes storing any data block in the front-end cache, the processor 210 may convert the field associated with the node ID included in the metadata information into a pointer. The pointer may indicate node ID information stored in a B+ tree form in a shared memory space.

Since this is only an example of the method for managing the metadata, the method for managing the metadata and a form thereof are not limited thereto.

The buffer cache data according to some exemplary embodiments of the present disclosure may be data copied from a data block stored in a disk. That is, the buffer cache data may correspond to data blocks stored in the disk or the front-end node. In some portions of the present disclosure, the buffer cache data and the data blocks may be used interchangeably.

In addition, the buffer cache data may be connected to at least one of the buffer header 400 and the metadata to be stored in the back-end cache 240.

When the metadata is managed as described above, it is possible to efficiently store information about the front-end node 100 that stores any data block in the front-end cache.

FIG. 3B is a diagram illustrating one example of a specific method for sharing a search structure.

As described above in FIG. 3A, the processor 210 may combine or separate a list of the buffer header 400 and a list of the metadata information in one hash bucket and store the lists in the back-end cache 240.

As illustrated in FIG. 3B, nodes of the list connected to one hash bucket 300a may be any one of a buffer header structure 400a, a metadata information structure 500a, and a general structure 700.

When the list of the buffer header 400 and the list of metadata information are separated and connected to the hash bucket 300a, the processor 210 finds the hash bucket using the data file number and what numberth block is the corresponding data block, and thus may find the buffer header, the metadata information, and the buffer cache data.

In the case where the list of the metadata information and the list of the buffer header 400 connected to the hash bucket 300a are integrated, the processor 210 first accesses the list using the general structure 700, and then may recognize type elements included in the buffer header structure 400a and the metadata information structure 500a to recognize whether the corresponding structure of the list corresponds to the buffer header 400 or the metadata information. When the type of the corresponding structure is recognized, the processor 210 may conduct processing appropriate to the corresponding type.

More specifically, if the buffer header structure 400a and the metadata information structure 500a included in the list are to be accessed as the type of general structure 700, the front parts of the two structures need to be unified. To this end, exemplarily, in FIG. 3A, there is an element of a structure list_link_t bucket_ link. The processor 210 may first access the list using the type of general structure 700, and then recognize the type elements included in the buffer header structure 400a and the metadata information structure 500a. When the type element is recognized, the processor 210 may conduct type-casting of the general structure 700 to the type element. The structure of the list type-cast to the type element may be processed according to an appropriate logic thereto. Since this is only an example of the method for sharing the search structure between the buffer header, the metadata information, and the buffer cache data, the scope of the present disclosure is not limited to the above-described example.

By the above-described method, the processor 210 may access all of the buffer header, the metadata information, and the buffer cache data with only a lock on one hash bucket. Therefore, since there is no need to hold a plurality of locks, the processing cost for searching of the processor 210 may be reduced, and the network cost may also be reduced.

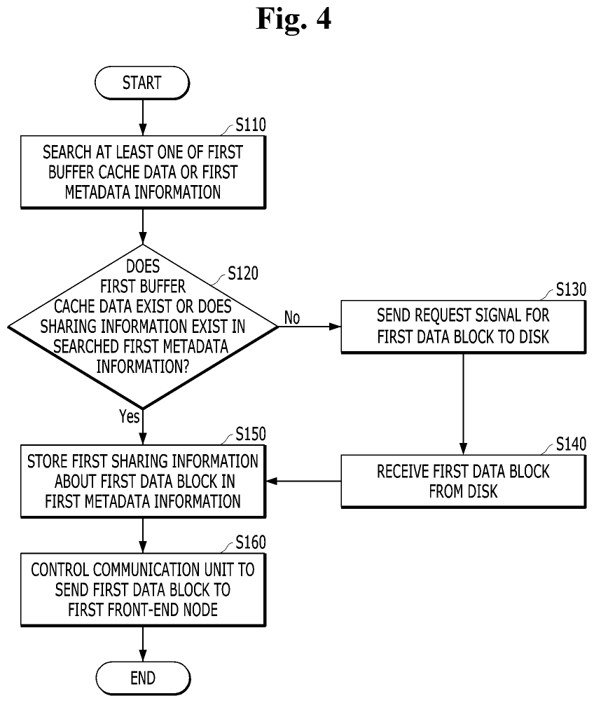

FIG. 4 is a flowchart illustrating that a processor of a back-end node transfers a data block to a front-end node according to some exemplary embodiments of the present disclosure.

Referring to FIG. 4, the processor 210 may search at least one of the first buffer cache data 600 or the first metadata information 500 in the back-end cache (S110).

When the first buffer cache data 600 exists or when the sharing information exists in the searched first metadata information 500 (S120, Yes), the processor 210 may store first sharing information about the first data block in the first metadata information 500 (S150).

The above-described step (S150) is conducted even when the first buffer cache data 600 exists and the sharing information exists in the searched first metadata information 500.

The sharing information according to some exemplary embodiments of the present disclosure may mean information that any data block has been stored in any front-end cache. That is, the first sharing information about the first data block may means information that the first data block is stored in the front-end cache of the first front-end node.

As another example, the first sharing information about the second data block may mean information indicating that the second data block has been stored in the front-end cache of the first front-end node.

For example, the sharing information may be a bit form. Here, it is assumed that a bit value of the first sharing information about the first data block is 1. In this case, the processor 210 may recognize that the first sharing information about the first data block exists. In this case, the processor 210 may recognize that the sharing information about the first data block exists.

In contrast, if a bit value of the first sharing information about the first data block is 0, the processor 210 may recognize that there is no first sharing information about the first data block. In this case, the processor 210 may recognize that there is no sharing information about the first data block.

As another example, the sharing information may be expressed in a chain form. In this case, the processor 210 may recognize the presence of the first sharing information according to whether the first sharing information about the first data block exists on a chain.

In addition, the sharing information may also include information about the number of front-end nodes storing any data block in the front-end cache. For example, if a value of the information about the number of front-end nodes storing the first data block in the front-end cache is 0, the processor 210 may recognize that there is no sharing information about the first data block.

When there is no sharing information about a specific data block, the processor 210 may recognize that the “specific data block has been not shared even at any front-end node”.

This is merely an example of a method for recognizing sharing information about any data block by the processor 210. A format of the sharing information and a recognition method thereof are not limited to those described above, and may be appropriately modified according to a format of the sharing information shown in the present disclosure and a format of the metadata information consisting of the sharing information.

Therefore, even when the processor 210 searches for the first metadata information in the back-end cache 240, if there is no sharing information in the first metadata information, the processor 210 may not send the first data block to the front-end node by receiving the first data block from another front-end node unless the first buffer cache data exists in the back-end cache 240. Therefore, in this case, the processor 210 receives the first data block from the disk to send the received first data block to the first front-end node.

The metadata information according to the present disclosure may include individual sharing information, and the synthesis of individual sharing information about any data block may constitute metadata information.

For example, when there are three front-end nodes according to an exemplary embodiment of the present disclosure, the first metadata information 500 about the first data block may include first sharing information about the first data block, second sharing information about the first data block, and third sharing information about the first data block.

In some exemplary embodiments according to the present disclosure, the metadata information may be included in the buffer header 400.

For example, when the first buffer cache data 600 is searched in the back-end cache 240, the processor 210 may store the first sharing information about the first buffer cache data 600 (the first data block) in the first metadata information 500 and then send the first buffer cache data 600 (the first data block) to the first front-end node.

As another example, when the sharing information exists in the searched first metadata information 500, the processor 210 searches for second sharing information about the first data block included in the first metadata information 500 to receive the first data block from the second front-end node. Thereafter, the processor 210 may store the first sharing information about the first data block in the first metadata information 500 and then control a communication unit to send the first data block to the first front-end node.

At this time, the processor 110 of any front-end node which receives a request signal for the first data block from the back-end node 200 searches for the first data block in the front-end cache and may send the first data block to the back-end node if the first data block exists in the front-end cache.

As described above, even if only either the metadata information or the buffer cache data exists in the back-end cache, a select query request for the first data block may be processed without an access to the disk. Therefore, reduction of network cost and improvement of processing speed may be achieved.

When the first buffer cache data 600 and the sharing information exist and the first metadata information 500 does not exist in the back-end cache (S120, No), the processor 210 may send a request signal for the first data block to the disk (S130).

The processor 210 may receive the first data block from the disk (S140).

According to some exemplary embodiments of the present disclosure, the processor 210 may control the communication unit 220 to send the request signal for the first data block to the disk 300 when the first metadata information is not searched while the first buffer cache data is not searched in the back-end cache 240 or when the sharing information does not exist therein even if the first metadata information is searched. When the processor 210 receives the first data block from the disk 300, the processor 210 may control the communication unit 220 to send the first data block to the first front-end node. The processor 210 may process a request for the first data block of the first front-end node by sending the first data block received from the disk 300 to the first front-end node.

Separately, in the searching process of the first metadata information in which the sharing information exists, it is obvious that the processor 210 can recognize whether the first metadata information itself (regardless of whether the sharing information exists) exists in the back-end cache 240. Thus, when the first metadata information 500 dose not exist in the back-end cache 240, the processor 210 may generate or load a first data structure that may accommodate the first metadata information 500, store information of the first data block in the first data structure, and decide the first data structure as the first metadata information 500. Here, the first data structure may be a structure having the same format as the metadata information.

The processor 210 may control the communication unit to send the first data block to the first front-end node (S160).

As described above, when the first buffer cache data 600 exists in the back-end cache 240, the processor 210 of the back-end node 200 may send the first buffer cache data 600 to the first front-end node. The first buffer cache data 600 may be the same as the first data block stored in the front-end nodes recorded in the disk or the first metadata.

The first front-end node that has received the first data block may decide whether to store the first data block in the front-end cache 140 using the optimizer 130 included in the front-end node.

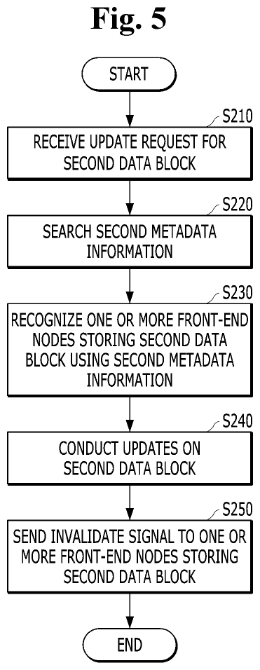

FIG. 5 is a flowchart illustrating a process in which a processor of a back-end node updates a data block according to some exemplary embodiments of the present disclosure.

In the present disclosure, updating on the data block may mean recording a change in the data block occurring through additional input of data for the data block, correction of data, or deletion of data to the back-end cache 240.

In the cloud database system according to the present disclosure, since the update may occur at the back-end node 200, a process of removing the updated data blocks from the front-end cache before recording the update in the back-end cache 240 is required.

Referring to FIG. 5, the processor 210 may receive an update request for a second data block (S210).

The back-end cache 240 according to the present disclosure may enable both reading and writing. Thus, the update request for any data block may be conducted by the processor 210 of the back-end node 200.

The processor 210 may search second metadata information (S220).

In this case, when the second metadata information does not exist, the processor 210 according to some exemplary embodiments of the present disclosure may conduct updates on the second data block. Since there is no front-end node storing the second data block in the front-end cache, subsequent steps may no longer be needed.

The processor 210 may recognize one or more front-end nodes storing the second data block by using the second metadata information (S230).

In step S230, information about the front-end node 100 in which the second data block is to be deleted from the front-end cache may be determined.

The processor 210 may conduct updates on the second data block (S240).

In FIG. 5, step S250 is illustrated to be conducted after conducting step S240. However, this is only for convenience of description, and the order of steps S240 and S250 is not limited thereto. That is, an invalidate signal may be sent from the back-end node 200 to the front-end node regardless of time when the processor 210 conducts updates on the second data block.

In addition, the processor 210 according to some exemplary embodiments of the present disclosure may conduct updates on the second data block not only synchronously but also asynchronously.

The processor 210 may send an invalidate signal to one or more front-end nodes storing the second data block (S250).

When the processor 210 receives an invalidate completion signal from all of the one or more front-end nodes that have sent the invalidate signal, the processor 210 may send an update completion signal to the first front-end node that has requested the update.

For example, the processor 210 according to some exemplary embodiments of the present disclosure may conduct updates on the second data block, and then recognize whether to receive a completion signal for the invalidate signal from all of the one or more front-end nodes sending the invalidate signal. When the processor 210 receives the completion signal for the invalidate signal from all of the one or more front-end nodes which have sent the invalidate signal, the processor 210 may send an update completion signal for the second data block to the first front-end node.

As described above, even when data blocks are stored in the plurality of front-end nodes 100 and back-end nodes 200, respectively, the update may be conducted by maintaining the correspondence between the data blocks between the front-end node 100 and the back-end node 200.

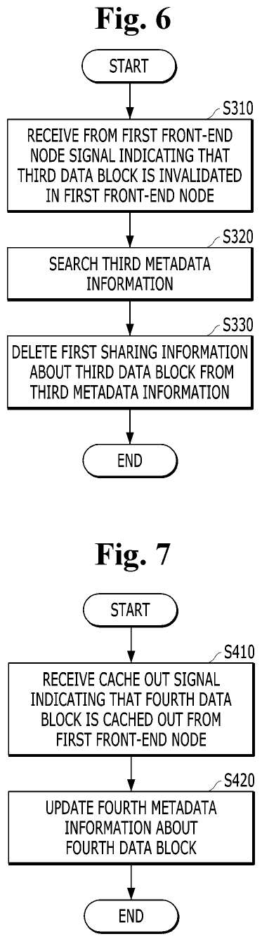

FIG. 6 is a flowchart illustrating a process in which a processor of a back-end node updates information of a data block invalidated in a front-end node according to some exemplary embodiments of the present disclosure.

The processor 210 may receive a signal indicating that a third data block is invalidated at the first front-end node, from the first front-end node (S310).

The invalidate of the data block according to the present disclosure may mean deleting the data block stored in the cache from the cache.

The processor 210 may receive a signal indicating that the third data block is invalidated in the front-end cache 140, from the front-end node 100 and then reflect the signal to the metadata information.

That is, the processor 110 according to some exemplary embodiments of the present disclosure may invalidate the third data block from the front-end cache when receiving an invalidate signal for the third data block.

In addition, the processor 110 may conduct invalidation by switching the third data block stored in a current state in the front-end cache to a consistent read (CR) state.

Therefore, the data block switched to the CR may be reused later. For example, when a query is requested for a block switched to the CR, the processor 110 may compare the block switched to the CR with a block recorded in a snapshot. If the block switched to the CR and the block recorded in the snapshot are the same as each other, the processor 110 may return the block switched to the CR.

The processor 210 may search third metadata information associated with the third data block (S320).

Here, third metadata information may mean information of front-end nodes that include the third data block in the front-end cache.

The processor 210 may delete first sharing information about the third data block from the third metadata information (S330).

The processor 210 may indicate that the third data block no longer exists in the front-end cache of the first front-end node by deleting the first sharing information about the third data block included in the third metadata.

As described above, it is possible to keep a continuous track of the front-end nodes storing any data block in the front-end cache. Therefore, the processor may quickly find the front-end nodes having the data block when a search request for the data block is made later, so that the network cost may be reduced and the processing speed of the select query may be increased.

FIG. 7 is a flowchart illustrating a process in which when a data block is cached out from a front-end cache, a processor of a back-end node updates the data block according to some exemplary embodiments of the present disclosure.

Referring to FIG. 7, the processor 210 may receive a cache out signal indicating that a fourth data block has been cached out from the first front-end node (S410).

The cache out according to some exemplary embodiments of the present disclosure may mean that any data block stored in the front-end cache 140 in the current state is switched to a consistent read (CR) state by the processor 110 of the front-end node 100. However, the front-end node 100 may also delete the corresponding data block on the memory. In other words, the conducting of the cache out is not limited to the above-described methods.

The processor 110 of the front-end node 100 according to some exemplary embodiments of the present disclosure may decide a data block to be cached out using a preset method.

For example, the processor 110 of the front-end node 100 may cache out a specific data block from the front-end cache 140 using least recently used (LRU), which is a kind of page replacement algorithm. That is, any front-end node 100 may cache out from the front-end cache 140 a data block for which the select query has not been conducted for the longest time among the data blocks stored in the front-end cache 140.

This is merely an example of deciding the data block to be cached out, and various rules may be used to decide the data block to be cached out.

The processor of the back-end node 200 may manage the data block storage state in any front-end cache 140 by adjusting only the metadata information. Therefore, while maintaining the front-end cache 140, it is possible to reduce the network cost required for managing the front-end cache 140.

The processor 110 may recognize the fourth data block to be cached out from the front-end cache 140. After recognizing the fourth data block to be cached out from the front-end cache 140, the processor 110 may cache out the fourth data block from the front-end cache 140. Thereafter, a cache out signal indicating that the fourth data block is cached out from the front-end cache 140 may be sent to the back-end node 200.

The processor 210 may update fourth metadata information about the fourth data block (S420).

Here, updating on the metadata information may mean removing sharing information about the front-end node in which the fourth data block is cached out from the fourth metadata information.

As described above, when a specific data block is cached out from the front-end node 100, the specific data block may be reflected to the metadata information included in the back-end cache 240. Thus, unnecessary access to the front-end node from which the corresponding data block is deleted may be reduced, thereby reducing the network cost.

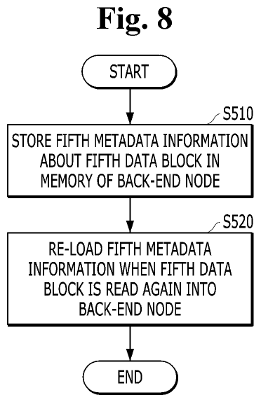

FIG. 8 is a flowchart illustrating a process in which when a data block which is cached out is stored in a back-end cache again, a processor of a back-end node loads metadata information according to some exemplary embodiments of the present disclosure.

Referring to FIG. 8, the processor 210 may store fifth metadata information about a fifth data block in a memory of a back-end node (S510).

When the fifth data block is cached out from the back-end cache 240, the processor 210 may store fifth metadata information corresponding to the fifth data block in the memory of the back-end node.

The cache out according to some exemplary embodiments of the present disclosure may mean that any data block stored in the front-end cache 240 in the current state is switched to a consistent read (CR) state by the processor 210 of the back-end node 200. However, the front-end node 200 may also delete the corresponding data block on the memory. In other words, the conducting of the cache out is not limited to the above-described methods.

The processor 210 of the back-end node 200 according to some exemplary embodiments of the present disclosure may decide a data block to be cached out using a preset method.

For example, the processor 210 of the back-end node 200 may cache out a specific data block from the back-end cache 240 using least recently used (LRU), which is a kind of page replacement algorithm. That is, any back-end node 200 may cache out from the back-end cache 240 a data block for which the select query has not been conducted for the longest time among the data blocks stored in the back-end cache 240.

This is merely an example of deciding the data block to be cached out, and various rules may be used to decide the data block to be cached out.

In particular, the processor 210 may leave the fifth metadata information in the back-end cache 240 even when the fifth data block is cached out.

When the fifth data block has been read into the back-end node, the processor 210 may reload the fifth metadata information (S520).

Then, the processor 210 may read the fifth metadata information which has been prestored in the memory (or the back-end cache 240) again when the fifth data block has been read again into the back-end cache 240 in the form of buffer cache data.

Specifically, the processor 210 according to some exemplary embodiments of the present disclosure may reload the fifth metadata information when the fifth data block is read into the back-end node 200 again.

Particularly, the reloading of the fifth metadata information may be conducted by recognizing the fifth metadata information and recording the fifth metadata in the buffer header 400 associated with the fifth data block when it is recognized that the fifth data block is read into the back-end cache.

As described above, even if a specific data block is deleted from the back-end cache 240, the processor 210 of the back-end node 200 may access information on the front-end node 100 which has still stored the corresponding data block in the front-end cache 140. Accordingly, the data block may be brought out by accessing the front-end node 100 without access to the disk 300, thereby reducing network costs.

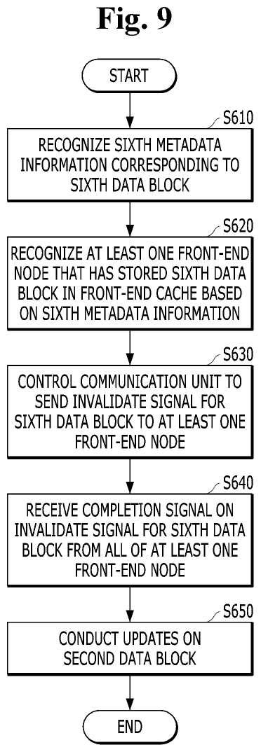

FIG. 9 is a flowchart illustrating a process in which a processor of a back-end node deletes metadata information of a data block from a back-end cache according to some exemplary embodiments of the present disclosure.

Referring to FIG. 9, the processor 210 may recognize sixth metadata information corresponding to a sixth data block (S610).

Here, the sixth metadata information may mean metadata information to be deleted from the back-end cache 240.

As a result, the processor 210 may recognize information about the front-end nodes 100 storing the sixth data block in the front-end cache 140.

The processor 210 may recognize at least one front-end node that has stored the sixth data block in the front-end cache based on the sixth metadata information (S620).

When the sixth metadata information is deleted, it is impossible to access the information about the front-end node 100 that has stored the sixth data block in the front-end cache 140 on the back-end cache 240. Accordingly, it is required to delete the sixth data block from the front-end cache 140 of the front-end node 100 in accordance with the deletion of the sixth metadata information.

The processor 210 may control the communication unit to send the invalidate signal for the sixth data block to at least one front-end node (S630).

The invalidate of the data block according to the present disclosure may mean deleting the data block stored in the cache from the cache.

The processor 210 may receive a completion signal on the invalidate signal for the sixth data block from all of at least one front-end node (S640).

The processor 210 may delete the sixth metadata information from the back-end cache 240 (S650).

As described above, while the sixth metadata information is deleted from the back-end cache 240, the sixth data block may be deleted from the at least one front-end nodes 100 accordingly.

Therefore, when it is required to ensure the storage space in the back-end cache 240, it is possible to be deleted sequentially from the metadata information having a lower need. Accordingly, efficient use of the storage space is possible.

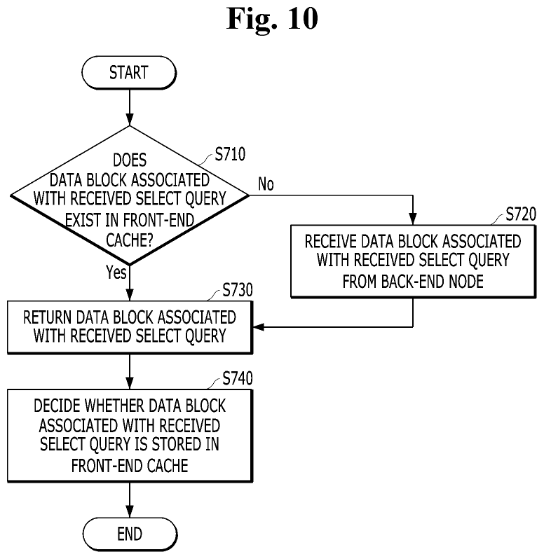

FIG. 10 is a flowchart illustrating a process in which a processor of a front-end node stores a data block in a front-end cache according to some exemplary embodiments of the present disclosure.

Referring to FIG. 10, the processor 110 may recognize whether a data block associated with the received select query exists in the front-end cache (S710).

In the present disclosure, the query means a predetermined request or command of requesting processing in a back-end node and may include, for example, data manipulation language (DML), data definition language (DDL), and/or PL/SQL. Further, the query in the present disclosure may mean a predetermined request issued from a user/developer. Further, the query may mean a predetermined request which is input into a front-end node and/or a back-end node and processed in the front-end node and/or the back-end node.

For example, the processor 110 may search the front-end cache 140 in order to decide whether a first data block associated with the received select query exists in the front-end cache 140. When the first data block exists in the front-end cache 140, the processor 110 may decide that the first data block exists in the front-end cache. Meanwhile, when the first data block does not exist in the front-end cache 140, the processor 110 may decide that the first data block does not exist in the front-end cache.

This is an example in which the processor 110 decides whether the data block associated with the received select query exists in the front-end cache 140, and thus the scope of the present disclosure is not limited thereto.

When the data block associated with the select query does not exist in the front-end cache (S710, No), the processor 110 may receive the data block associated with the select query received from the back-end node (S720).

As described above, the data block associated with this select query may be to be received from another front-end node 100 or back-end node 200.

In this case, the optimizer 130 may decide whether to store the front-end cache 140 with respect to the received select query.

When the data block associated with the select query exists in the front-end cache (S710, Yes), the processor 110 may return the data block associated with the received select query (S730).

As described above, the return of the data block may mean providing a user requesting the select query according to the present disclosure with information of the data block associated with the select query.

The processor 110 may decide whether to store the data block associated with the received select query in the front-end cache (S740).

In this case, the optimizer 130 may decide whether to use the front-end cache 140 in consideration of a type of scan associated with the select query, a size of a target segment, a level of filtering, an access frequency, and the like.

A segment according to the present disclosure may mean an object using a disk storage space. In other words, any object having a storage space may be a segment.

If the size of the segment is large, there may be many surplus blocks other than the data block associated with the select query. Therefore, storing the entire corresponding segment in the front-end cache may use a cache space inefficiently. Thus, in general, the optimizer 130 may decide not to store the corresponding segment in the front-end cache 140 when the segment size is large.

The level of filtering may mean a function of selecting only data that satisfies a condition defined by the user. When the optimizer 130 recognizes that the type of the scan associated with the select query is the table full scan and the result filtering on the small table is small, the optimizer 130 may decide to store the data block associated with the select query in the front-end cache 140. However, the present disclosure is not limited thereto.

The access frequency may mean the number of access requests per unit time for any data block associated with the select query.

For example, the optimizer 130 may be configured to store the corresponding data block in the front-end cache 140 as the frequency of past accesses to any data block associated with the select query is higher. On the contrary, the optimizer 130 may be configured to store the corresponding data block in the front-end cache 140 as the frequency of past accesses to any data block associated with the select query is lower.

By maintaining the front-end cache 140 as described above, it is possible to directly process a select query with respect to the data blocks to be frequently accessed without requesting data blocks to the back-end node 200. In addition, the front-end cache may be used more efficiently when the optimizer decides the data blocks stored in the front-end cache by considering various factors. Therefore, the network cost required to conduct the select query may be reduced.

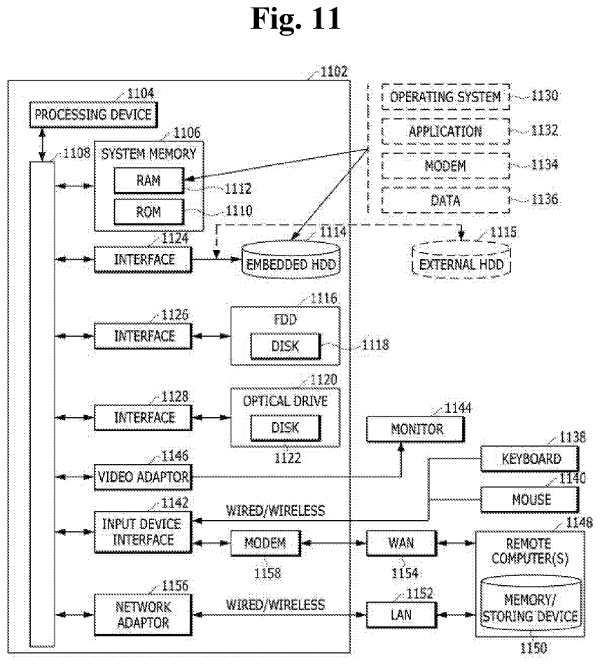

FIG. 11 is a simple and general schematic view for an exemplary computing environment in which some exemplary embodiments of the present disclosure may be implemented.

The computer 1102 illustrated in FIG. 11 may correspond to at least one of computing devices constituting the front-end node 100, the back-end node 200, the disk 300, and a communication network (not illustrated).

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices) as well as a single-processor or multi-processor computer system, a mini computer, and a main frame computer.

The exemplary embodiments described in the present disclosure may also be implemented in a distributed computing environment in which predetermined tasks are conducted by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media.

A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in sending information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated)—, a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch scene, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operate by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to send and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Further, various exemplary embodiments presented herein may be implemented as manufactured articles using a method, an apparatus, or a standard programming and/or engineering technique. The term “manufactured article” includes a computer program, a carrier, or a medium which is accessible by a predetermined computer readable device. For example, a computer readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is decided that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is consistent with the principles and new features presented herein.

What is claimed is:

1. A back-end node for a cloud database system comprising:
a communication unit;
a back-end cache storing buffer cache data and metadata information, wherein the buffer cache data and the metadata information correspond with a data block stored in the database system; and
a processor;
wherein the metadata information includes information of a front-end node which stores the metadata block in its front-end cache.

2. The back-end node of claim 1, wherein the back-end cache further comprises a buffer header corresponding to the buffer cache data, and the buffer header includes the metadata information.

3. The back-end node of claim 1, wherein the back-end cache further comprises a buffer header corresponding to the buffer cache data, and the metadata information shares the same search structure with the buffer cache data.

4. The back-end node of claim 3, wherein the buffer header and the metadata information share the search structure by:
being stored in the back-end cache using same hash function;
having the same input value for the hash function related to the buffer header and the metadata information; and
the space in which the buffer header and the metadata information are stored within the search structure, and the result value attained from inputting the input value to the hash function being related.

5. The back-end node of claim 1, wherein the metadata information includes one of the following: a bitmap, a node ID information in the form of an array or a pointer indicating the node ID information expressed as B+ Tree in the shared memory space.

6. The back-end node of claim 1, wherein the processor:
searches at least either one of the first buffer cache data or the first metadata information in the back-end cache when receiving a request to send a first data block from a first front-end node through the communication unit;
controls the communication unit to send the first data block to the first front-end node based on at least either one of the first buffer cache data or the first metadata information when the first buffer cache data is searched or a sharing information exists on the searched first meta data information; and
stores the first sharing information on the first data block to the first metadata information, wherein the first sharing information on the first data block is information which indicates that the first data block is stored on the first front-end node.

7. The back-end node of claim 6, wherein the processor:
searches second sharing information on the first data block included in the first metadata information when the sharing information exists in the first metadata information, wherein the second sharing information on the first data block indicates that the first data block is stored on a second front-end node;
receives the first data block from the second front-end node through the communication unit; and
controls the communication unit to send received first data block to the first front-end node.

8. The back-end node of claim 6, wherein the processor when the first metadata information does not exist in the back-end cache:
generates or loads a first data structure which is able to store the first metadata information
stores information of the first data block to the first data structure; and
decides the first data structure as the first metadata information.

9. The back-end node of claim 6, wherein the processor controls the communication unit to send the first buffer cache data to the first front-end node, when the first buffer cache data exists in the back-end cache.

10. The back-end node of claim 6, wherein the processor:
controls the communication unit to send a request signal for the first data block to a disk when the first buffer cache and the sharing information does not exist in the searched first metadata information; and
controls the communication unit to send the first data block to the first front-end node when receiving the first data block from the disk.

11. The back-end node of claim 1, wherein the processor:
searches second metadata information when the communication unit receives an update request on a second data block from the first front-end node, and
conducts update on the second data block with reference to the second metadata information.

12. The back-end node of claim 11, wherein the processor:
searches first sharing information on the second data block included in the second metadata information when the second metadata information exists in the back-end cache, wherein the first sharing information on the second data block indicates that the second data block has been stored in the first front-end node;
receives the second data block from the first front-end node through the communication unit;
stores the second data block to the back-end cache; and
conducts updates on the second data block.

13. The back-end node of claim 11, wherein the processor:
recognizes one or more front-end nodes which has stored the second data block using the second metadata information;
controls the communication unit to send an invalidate signal that makes one or more front-end node invalidate the second block from front-end cache of each of the one or more front end nodes; and
conducts updates on the second data block synchronously or asynchronously and controls the communication unit to send invalidate signals.

14. The back-end node of claim 13, wherein the processor acts as the following when the update on the second data block is asynchronously done with sending invalidate signals:
conducts updates on the second data block;
recognizes whether the completion signal on the invalidate signals are received from all of one or more front-end nodes; and
sends an update completion signal on the second data block to the first front-end node when the completion signal on the invalidate signals are received from all of one or more front-end nodes.

15. The back-end node of claim 11, wherein the processor conducts updates on the second data block, when the second metadata information does not exist.

16. The back-end node of claim 1, wherein the processor:
searches for third metadata information when a signal that a third data block has been invalidated from the first front-end node is received from the first front-end node; and
deletes the first sharing information on the third data block from the third metadata information, wherein the first sharing information on the third data block indicates that the third data block is stored in the first front-end node.

17. The back-end node of claim 1, wherein the processor updates fourth metadata information on a fourth data block based on the cache out signal, when the communication unit receives the cache out signal that indicates the fourth data block is cached out from the first front-end node from the first front-end node.

18. The back-end node of claim 2, wherein the processor stores fifth metadata information on a fifth data block in a memory of the back-end node when the fifth data block is cached out from the back-end cache.

19. The back-end node of claim 18, wherein the processor re-loads the fifth metadata information when the fifth data block is read again into the back-end node.

20. The back-end node of claim 19, wherein, when the fifth metadata information is re-loaded, the processor:
recognizes the fifth metadata information when it recognizes that the fifth data block has been read into the back-end cache; and
records the fifth metadata information on the buffer header related to the fifth data block.

21. The back-end node of claim 1, wherein the processor:
recognizes sixth metadata information corresponding to a sixth data block,
recognizes at least one front-end node that stores the sixth data block in front-end cache based on the sixth metadata information,
controls the communication unit to send an invalidate signal on the sixth data block to at least one of the front-end nodes, and
deletes the sixth metadata information from the back-end cache when a completion signal for the invalidate signal on the sixth data block is received from all of the front-end nodes.

22. A front-end node of the cloud database system comprising:
a front-end cache storing one or more data blocks;
a communication unit receiving data blocks related to select query from a back-end node; and
a processor storing the data block to the front-end cache when the data block has been decided to be stored in the front-end cache.

23. The front-end node of claim 22, further comprising:
an optimizer that decides if the data block is to be stored in the front-end cache or not using at least one of the following: a type of scan, a size of a target segment, level of filtering or access frequency.

24. The front-end node of claim 22, wherein the processor:
searches the first data block from the front-end cache when receiving a request signal for a first data block from the back-end node; and
send the first data block to the back-end node when the first data block exists in the front-end cache.

25. The front-end node of claim 22, wherein the processor:
invalidates the third data block from the front-end cache when an invalidate signal for the third data block to be invalidated from the front-end cache is received from the back-end node, and
controls the communication unit to send a completion signal for the invalidate signal that indicates that the third data block has been invalidated to the back-end node.

26. The front-end node of claim 25, wherein the processor switches the state of the third data block to CR (Consistent Read) state which is stored in the front-end cache as a current state when invalidating the third data block from the front-end cache.

27. The front-end node of claim 22, wherein the processor:
recognizes a fourth data block when cached out from the front-end cache,
controls the front-end cache to cache out the fourth data block from the front-end cache, and
controls the communication unit to send the cache out signal which indicates that the fourth data block has been cached out from the front-end cache to the back-end node.
